(19) United States
(12) Patent Application Publication
(10) Pub. No.: US 2024/0087790 A1
(43) Pub. Date: Mar. 14, 2024

(54) OVERTEMPERATURE DETECTING SYSTEM, OVERTEMPERATURE PROTECTING SYSTEM, AND OVERTEMPERATURE DETECTING METHOD

(71) Applicant: TOSHIBA MITSUBISHI-ELECTRIC INDUSTRIAL SYSTEMS CORPORATION, Chuo-ku (JP)

(72) Inventor: Masashi FUKUDA, Tokyo (JP)

(73) Assignee: TOSHIBA MITSUBISHI-ELECTRIC INDUSTRIAL SYSTEMS CORPORATION, Chuo-ku (JP)

(21) Appl. No.: 18/263,175

(22) PCT Filed: Sep. 3, 2021
(86) PCT No.: PCT/JP2021/032396

§ 371 Date: Jul. 27, 2023

(51) Int. Cl. H01F 27/08

(52) U.S. Cl. CPC H01F 27/085; H01F 2027/406

(57) ABSTRACT

An overtemperature detecting system according to an embodiment detects a temperature abnormality of a dry-type transformer (hereinafter, referred to as a transformer) cooled by a cooling device. The overtemperature detecting system includes a temperature determining unit. The temperature determining unit determines and outputs a temperature abnormality of the transformer by changing determination conditions of the temperature abnormality of the transformer using operation states during operating and during stopping of the cooling device.

### TECHNICAL FIELD

Embodiments of the present invention relate to an overtemperature detecting system, an overtemperature protecting system, and an overtemperature detecting method.

### BACKGROUND ART

In an overtemperature detecting system, a temperature detector is disposed near a dry-type transformer (referred to as a transformer) cooled by a cooling device and the temperature of the transformer may be indirectly detected by estimating the temperature instead of directly measuring a temperature of the transformer through a contact. There are cases in which the transformer is protected using a result of detection acquired by the temperature detector. However, there are cases in which detection accuracy for appropriate protection cannot be acquired using such a temperature detecting method.

### CITATION LIST

### Patent Document

### Patent Document 1

Japanese Unexamined Patent Application, First Publication No. 2010-193695

### SUMMARY OF INVENTION

### Technical Problem

An object of the present invention is to provide an overtemperature detecting system, an overtemperature protecting system, and an overtemperature detecting method detecting a temperature abnormality of a transformer cooled by a cooling device.

### Solution to Problem

An overtemperature detecting system according to an embodiment detects a temperature abnormality of a dry-type transformer (hereinafter, referred to as a transformer) cooled by a cooling device. The overtemperature detecting system includes a temperature determining unit. The temperature determining unit determines and outputs a temperature abnormality of the transformer by changing determination conditions of a temperature abnormality of the transformer using operation states during operating and during stopping of the cooling device.

### BRIEF DESCRIPTION OF DRAWINGS

FIG. 1A is a schematic configuration diagram of a transformer board to which an overtemperature detecting system according to an embodiment is applied.

FIG. 1B is a plan view of a transformer board 1 according to an embodiment.

FIG. 2 is a schematic configuration diagram of the vicinity of a transformer board according to an embodiment.

FIG. 3 is a configuration diagram of a temperature determining unit according to an embodiment.

FIG. 4 is a diagram illustrating the temperature of a transformer 2 relating to a hot start time according to an embodiment.

FIG. 5 is a block diagram of a temperature determining unit 5D according to a second embodiment.

### DESCRIPTION OF EMBODIMENTS

Hereinafter, an overtemperature detecting system, an overtemperature protecting system, and an overtemperature detecting method according to embodiments will be described with reference to the drawings.

In the following description, the same reference sign will be assigned to components having the same function or functions similar to each other. Duplicate description of such components may be omitted. In addition, being electrically connected may be simply referred to as “being connected”. “A measured value of a voltage” represented in the following description is a measured value of an actual voltage, an index value representing a magnitude of an actual voltage, or an estimated value representing a magnitude of a voltage. In the following description, a “dry-type transformer” may be simply described as a “transformer”. In the description, “a temperature of a transformer”, and “a temperature of surrounding air of the transformer” may have the same meaning.

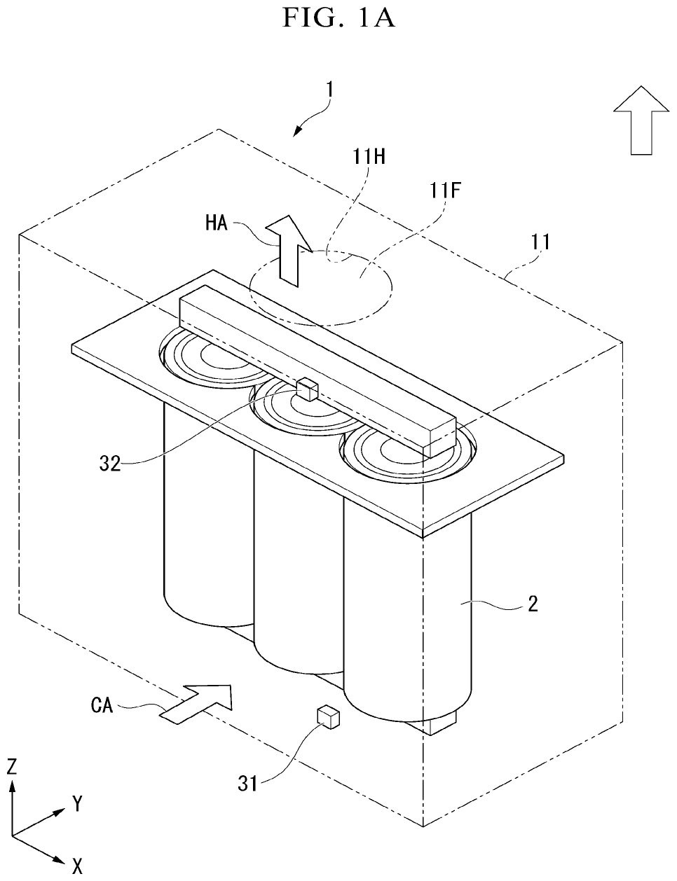

FIG. 1A is a schematic configuration diagram of a transformer board 1 to which an overtemperature detecting system 5A according to an embodiment is applied. FIG. 1B is a plan view of the transformer board 1 according to the embodiment.

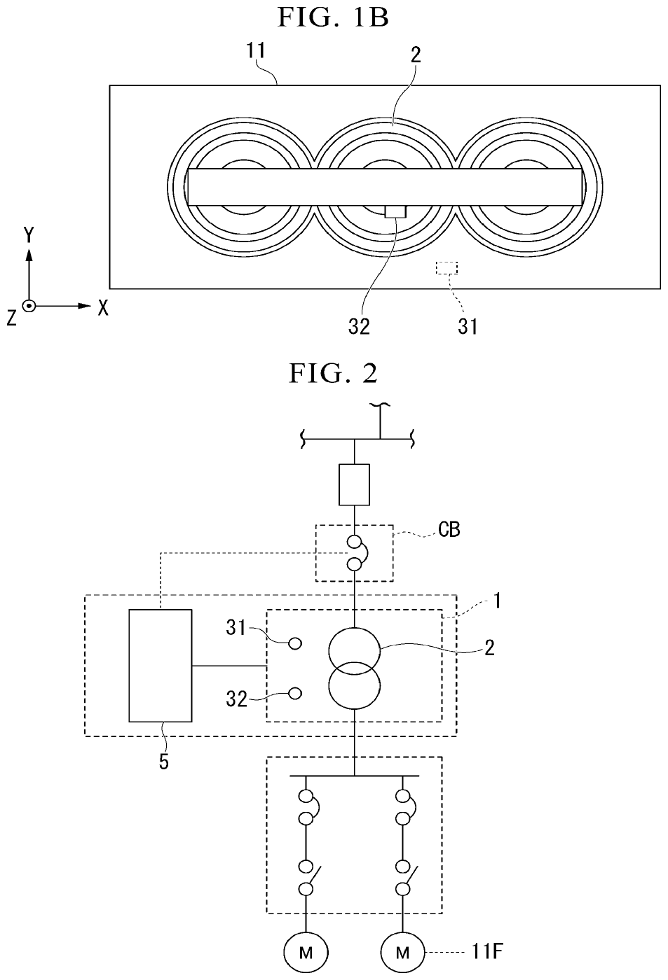

The transformer board 1 includes a transformer 2, a casing 11, a first temperature detector 31, a second temperature detector 32, and a temperature determining unit 5 (FIG. 2). The first temperature detector 31, the second temperature detector 32, and the temperature determining unit 5 configure one example of an overtemperature protecting system 10. The temperature determining unit 5 is one example of an overtemperature detecting system 5A.

The transformer 2, for example, is a three-phase transformer of a mold type. The transformer 2 is one example of a dry-type transformer. The transformer 2 is formed as a forced air cooling type that is cooled by a cooling device.

The casing 11 is configured to house the transformer 2 on the inside thereof. The transformer 2 is installed inside the casing 11. In the casing 11, a cooling device used for cooling the transformer 2 is disposed. The cooling device may be formed to include a fan 11F of an outside air introducing type that intakes room-temperature air (CA) and discharges hot air (HA). The fan 11F is one example of a cooling device disposed in an opening part 11H of the casing 11. For example, the opening part 11H of the casing 11 is disposed on a top face of the casing 11. An opening used for intaking room-temperature air (CA) may be disposed on a door face not illustrated in the drawing. In addition, a cooling device other than the fan 11F disposed in the casing 11 is allowed to be disposed and may be appropriately combined with the fan 11F.

The first temperature detector 31 detects a temperature of the vicinity (a first surrounding temperature) of the casing 11 into which external air has flowed. For example, the first temperature detector 31 is disposed at a stage lower than a coil part of the transformer 2 inside the opening part into which external air flows inside the casing 11. The position illustrated in the drawing is an example and is not limited thereto.

The second temperature detector 32 detects a surrounding temperature (a second surrounding temperature) of the transformer 2. The second temperature detector 32, for example, is disposed above a V-phase coil of the transformer 2 having coils of UVW phases near the transformer 2. This position is a position at which the influence of a main body temperature of the transformer 2 is easily received. The position illustrated in the drawing is an example and is not limited thereto.

The transformer 2 disposed inside the casing 11 of the transformer board 1 generates heat in accordance with a power loss thereof. This heat is discharged to outside of the casing 11 in accordance with an operation of the fan 11F of the casing 11. When the operation of the fan 11F of the casing 11 stops, heat accumulated in the transformer 2 at that stage may raise the temperature of the vicinity of the transformer 2.

FIG. 2 is a schematic configuration diagram of the vicinity of the transformer board 1 according to the embodiment.

An input-side circuit breaker CB is disposed on a primary side of the transformer board 1. The input-side circuit breaker CB enables electric power of a power supply side to be supplied to the primary side of the transformer board 1 in a conductive state. In a cut-off state, supply of electric power of the power supply side to the primary side of the transformer board 1 is cut off. The input-side circuit breaker CB is one example of a switch disposed on the primary side of the transformer 2. For example, the input-side circuit breaker CB is formed such that it is switched to a conductive state and a cut-off state in accordance with control.

Loads such as an electric motor (M), a cooling device (a fan 11F), and the like are connected to a secondary side of the transformer board 1 through a load-side circuit breaker, a disconnector, and the like.

The temperature determining unit 5 detects a temperature abnormality of the transformer 2. For example, the temperature determining unit 5 is connected to the first temperature detector 31 and the second temperature detector 32 disposed inside the casing 11. Furthermore, a state signal of the input-side circuit breaker CB is supplied to the temperature determining unit 5 such that a hot-line state of the primary side of the transformer 2 is detected. The state signal of the input-side circuit breaker CB may be a signal that represents a power application state of the load side of the input-side circuit breaker CB. Furthermore, the temperature determining unit 5 may output a control signal used for controlling a state of the input-side circuit breaker CB such that supply of electric power to the primary side of the transformer 2 is cut off.

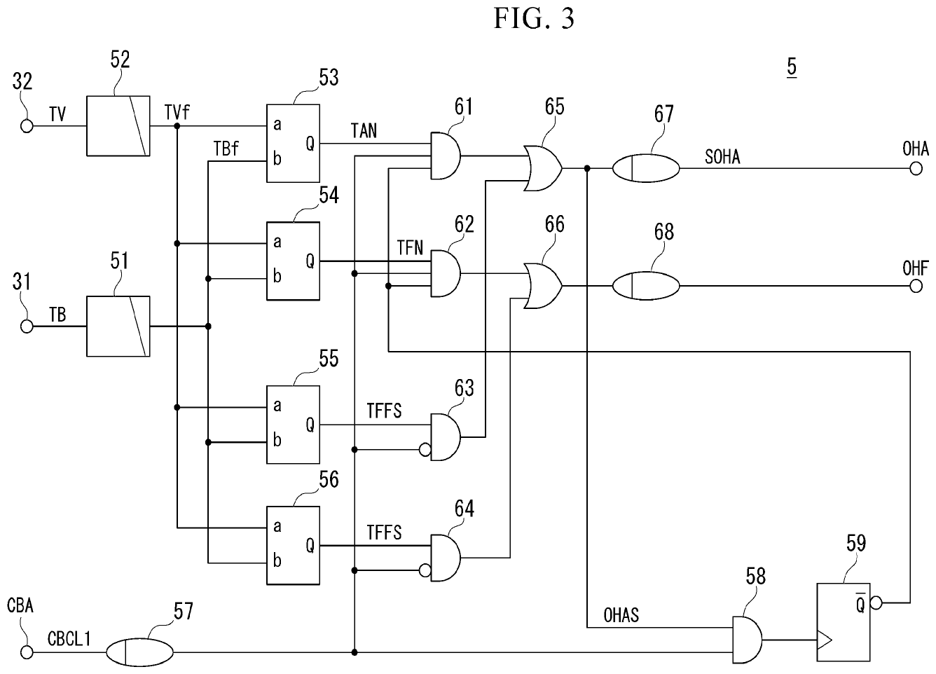

FIG. 3 is a configuration diagram of the temperature determining unit 5 according to the embodiment.

The temperature determining unit 5 includes filters 51 and 52, comparators 53 to 56, a filter 57, a gate 58, a one-shot gate 59, gates 61 to 66, and filters 67 and 68.

Each of the filters 51 and 52 is a smoothing circuit. Each of the filters 51 and 52 eliminates noise superimposed in an input signal. This smoothing circuit may be configured as a moving average circuit or may be configured as a lowpass filter. Characteristics thereof may be appropriately set such that a temperature change is detected.

For example, an output of the first temperature detector 31 is connected to an input of the filter 51, and a signal TB representing a result of detection acquired by the first temperature detector 31 is supplied to the input of the filter 51. The filter 51 outputs a signal TBf acquired by converting the signal TB. An output of the second temperature detector 32 is connected to an input of the filter 52, and a signal TV representing a result of detection acquired by the second temperature detector 32 is supplied to the input of the filter 52. The filter 52 outputs a signal TVf acquired by converting the signal TV.

Each of the comparators 53 to 56 detects an electric potential between the signal TBf and the signal TVf respectively supplied to two inputs exceeding a predetermined value set in advance. Predetermined values set in each of the comparators 53 to 56 are different from each other. For example, in order of the comparators 53 to 56, the predetermined values are assumed to be respectively set to ΔT1, ΔT2, ΔT3, and ΔT4.

The comparators 53 to 56 respectively output identification results as a signal TAN, a signal TFN, a signal TAFS, and a signal TFFS.

A first input of the gate 61 is connected to an output of the comparator 53.

A first input of the gate 62 is connected to an output of the comparator 54.

A first input of the gate 63 is connected to an output of the comparator 55.

A first input of the gate 64 is connected to an output of the comparator 56.

Each of the gates 61 to 64 is an AND circuit. A second input of each of the gates 63 and 64 is a negative logic. All the inputs of the gates 61 to 64 except for the second inputs of the gates 63 and 64 and inputs of the gate 58 and such outputs of the gates 61 to 64 of the gate 58 are positive logics.

A state signal CBCL1 of the input-side circuit breaker CB is supplied to a terminal CBA. The state signal CBCL1 is in a logic state ST1 at the time of the input-side circuit breaker CB being closed and is in a logic state ST0 at the time of the input-side circuit breaker CB being open. The terminal CBA is connected to an input of the filter 57.

When the logic state ST1 of the input signal exceeds a time set in advance, the filter 57 outputs the logic state ST1 at a timing delayed by the time and, when the input signal further changes to the logic state ST0, outputs the logic state ST0 in accordance therewith. In addition, the filter 57 generates an output signal storing the logic state of the input signal. For example, when the logic state ST1 continues for about 0.5 seconds after the input signal changes to the logic state ST1, the filter 57 may generate a pulse of the logic state ST1. The second inputs of the gates 61 to 64 and a second input of the gate 58 are connected to an output of the filter 57.

A set of the gate 58 and the one-shot gate 59 generates a mask signal for temporarily stopping detection of a temperature abnormality. For example, the gate 58 is an AND circuit. An output of the gate 58 is connected to a trigger input of the one-shot gate 59. When the trigger input in which an output signal of the gate 58 changes from the logic state ST0 to the logic state ST1 is detected, the one-shot gate 59 outputs a negative pulse having a predetermined length set in advance. For example, in this case, the one-shot gate 59 generates a pulse having the logic state ST0 continuing for 60 seconds. The output of the one-shot gate 59 is connected to third inputs of the gates 61 and 62. While the pulse having the logic state ST0 is supplied, the gates 61 and 62 to which the pulse having the logic state ST0 is supplied are deactivated and mask other input signals. In other words, while the pulse having the logic state ST0 is supplied, signals output from the comparators 53 and 54 are masked by the gates 61 and 62.

The gate 65 is an OR circuit of a positive logic input and a positive logic output. A first input of the gate 65 is connected to an output of the gate 61, and a second input is connected to an output of the gate 63. An input of the filter 67 is connected to an output of the gate 65.

When the logic state ST1 of the input signal exceeds a time set in advance, the filter 67 outputs the logic state ST1 at a timing delayed by that time and, when the input signal further changes to the logic state ST0, outputs the logic state ST0 in accordance therewith. In addition, the filter 67 generates an output signal storing the logic state of the input signal. For example, when the logic state ST1 of the input signal continues for about 1 second, the filter 67 may generate a pulse of the logic state ST1. An output of the filter 67 is connected to a terminal OHA and a first input of the gate 58.

The gate 66 is an OR circuit of a positive logic input and a positive logic output. A first input of the gate 66 is connected to an output of the gate 62, and a second input is connected to an output of the gate 64. An input of the filter 68 is connected to an output of the gate 66.

When the logic state ST1 of the input signal exceeds a time set in advance, the filter 68 outputs the logic state ST1 at a timing delayed by that time and, when the input signal further changes to the logic state ST0, outputs the logic state ST0 in accordance therewith. For example, when the logic state ST1 of the input signal continues for about one second, the filter 67 may generate a pulse having the logic state ST1. In addition, the filter 68 generates an output signal storing the logic state of the input signal. An output of the filter 68 is connected to a terminal OHF.

Subsequently, an operation of the temperature determining unit 5 will be described.

The temperature determining unit 5 identifies a difference between temperatures (a temperature difference) detected by the first temperature detector 31 and the second temperature detector 32 using the comparators 53 to 56, thereby detecting a temperature abnormality of the transformer 2. A state in which 1 is output to the terminal OHA represents a state in which a first stage of the temperature abnormality has been reached, and a state in which 1 is output to the terminal OHF represents a state in which a second stage of the temperature abnormality has been reached. The first stage of the temperature abnormality is a stage in which an alarm representing an occurrence of a temperature abnormality is notified, and the second stage of the temperature abnormality is a stage in which a state in which a temperature abnormality has occurred, and it is risky to continue the operation is notified.

If a delay time until the filter 57 responds is ignored in description, when the input-side circuit breaker CB is open, the state signal CBCL1 becomes the logic state ST0, and the gates 63 and 64 are activated. On the other hand, outputs of the gates 61 and 62 are deactivated, and input signals thereof are masked.

When the input-side circuit breaker CB is closed, the state signal CBCL1 becomes the logic state ST1, and the gates 61 and 62 are activated in accordance with the output state of the one-shot gate 59. On the other hand, the gates 63 and 64 are deactivated, and input signals are masked.

For example, when the input-side circuit breaker CB is open, identification results acquired by the comparators 55 and 56 become valid. When the input-side circuit breaker CB is closed, identification results acquired by the comparators 53 and 54 become valid.

An example of thresholds ΔT1, ΔT2, ΔT3, and ΔT4, which are respectively set in the comparators 53 to 56 used for detecting a temperature difference will be described. The thresholds ΔT2 and ΔT4 associated with the comparators 54 and 56 are set to a temperature difference for which the first stage of the temperature abnormality can be detected. The thresholds ΔT1 and ΔT3 associated with the comparators 53 and 55 are set to a temperature difference for which the second stage of the temperature abnormality can be detected. For example, 120 degrees, 125 degrees, 130 degrees, and 135 degrees are respectively set to the thresholds ΔT1, ΔT2, ΔT3, and ΔT4 as detection temperatures. In a case in which hysteresis is caused to be included, temperatures lower than the temperatures described above (for example, temperatures lower by 10 degrees) may be set.

In addition, when the input-side circuit breaker CB is closed, the thresholds ΔT1 and ΔT3 are set to a temperature difference for which a temperature abnormality at a normal time can be identified such that the comparators 53 and 54 respectively detect the second stage and the first stage of the temperature abnormality. When the input-side circuit breaker CB is open, the thresholds ΔT2 and ΔT4 are set to have a temperature difference higher than that of the thresholds ΔT1 and ΔT3 such that the comparators 55 and 56 respectively detect the second stage and the first stage of the temperature abnormality.

For example, as a determination condition of the temperature abnormality of the transformer 2, threshold temperatures including a first threshold temperature (the threshold ΔT1) used for determining a temperature of the transformer 2 during the operation of the cooling fan 11F and a second threshold temperature (the threshold ΔT3) used for determining a temperature of the transformer during stopping of the cooling fan may be provided. The second threshold temperature (the threshold ΔT3) described above may be set to a temperature lower than a threshold temperature (the threshold ΔT2) for detecting an event of stopping the system from the temperature of the transformer 2 during the operation of the cooling fan 11F. The temperature described above is an example represented as an example, is not limited thereto, and may be appropriately determined.

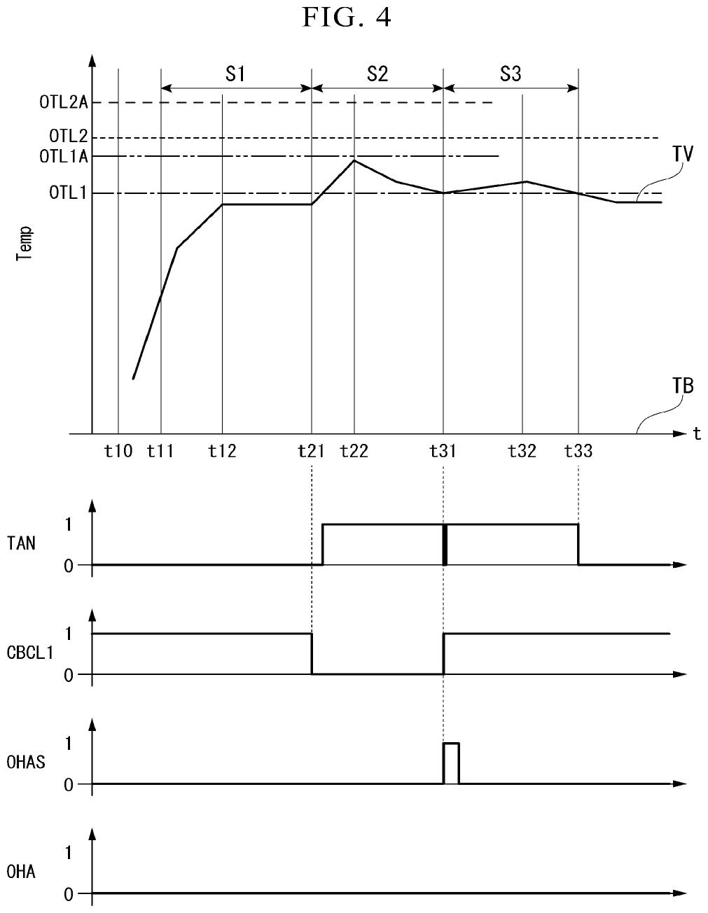

The temperature of the transformer 2 relating to a hot start time will be described with reference to FIG. 4.

FIG. 4 is a diagram illustrating the temperature of the transformer 2 relating to a hot start time according to an embodiment. In graphs illustrated in FIG. 4, a temperature difference between detection temperatures of the first temperature detector 31 and the second temperature detector 32 and changes in signals of respective parts with respect to time are illustrated. The graph illustrated in an uppermost level illustrates a temperature difference between the detection temperatures, a solid line TV stage in the graph illustrates a temperature difference between the detection temperatures of the first temperature detector 31 and the second temperature detector 32. In the following description, the temperature difference described above will be simply referred to as “a temperature of the transformer 2”. Graphs of the next level and subsequent levels respectively illustrate a signal TAN, a signal CBCL1, a signal OHAS, and a control signal SOHA. Each of the signal TAN, the signal CBCL1, the signal OHAS, and the control signal SOHA takes binary values of “0 (the logic state ST0) and “1 (the logic state ST1).

In an initial stage, supply of electric power from the transformer 2 to a load thereof stops. The signal TAN, the signal OHAS, and the control signal SOHA are “0”, and the signal CBCL1 is “1”.

At a time t10, supply of electric power from the transformer 2 to a load thereof starts, and the temperature of the transformer 2 detected by the second temperature detector 32 starts to rise.

At a time t11, when the temperature of the vicinity of the fan 11F is over an operation start temperature, the fan 11F starts to operate in accordance with temperature control of the fan 11F. When the temperature of the vicinity of the fan 11F is over the operation start temperature and thus is conductive, the fan 11F operates. In accordance with this, circulation of air for cooling starts inside the casing 11. A state of this stage will be referred to as a normal time state (state S1). In the state S1, a state in which the transformer 2 supplies electric power to the load thereof, and the fan 11F is operating is formed. In the state S1, when a situation in which the amount of heat generation according to a power loss of the transformer 2 and a cooling effect according to the fan 11F are balanced is formed, the temperature of the transformer 2 reaches thermal equilibrium (a time t12). In this stage, the temperature of the transformer 2 that is detected by the second temperature detector 32 is stable and is almost constant.

In addition, threshold temperatures OTL1 and OLT2 higher than the temperature at the time of thermal equilibrium are set for detection of a temperature abnormality. The threshold temperature OTL1 is set to a temperature that does not occur in a normal time situation in which the fan 11F is operating. Although this threshold temperature OTL1 is set to be higher than the temperature at the time of thermal equilibrium at a normal time, a difference between the threshold temperature OTL1 and the temperature at the time of thermal equilibrium may be set to be relatively small. In accordance with this, detection sensitivity at the time of an occurrence of a temperature abnormality can be improved. The threshold temperature OTL2 is set to a temperature that does not occur in the situation of a normal operation regardless of an operation/non-operation of the fan 11F. This threshold temperature OTL2 is set to be higher than the threshold temperature OTL1 and may have a value for which a temperature at which the risk of the transformer 2 malfunctioning is low is not erroneously detected as a temperature abnormality.

At a time t21, the input-side circuit breaker CB is open due to a certain factor, and the signal CBCL1 becomes “0”. This state represents a state (referred to as state S2) in which electric power is not supplied to the transformer 2. In accordance with the description presented above, supply of electric power to the transformer 2 stops, and thus generation of heat due to a loss according to the transformer 2 stops. However, there is heat accumulated in the transformer 2 before stopping of the supply of electric power, and the temperature of the vicinity of the transformer 2 rises in accordance with emission of this heat.

When this state S2 is formed, supply of electric power to the load of the transformer 2 stops as well, and thus the fan 11F cooling the transformer 2 does not operate. For this reason, a rise in the temperature on the vicinity of the transformer 2 according to emission of the heat described above is actualized, the rise in the temperature is detected by the second temperature detector 32, and the signal TAN becomes “1”.

In this way, the temperature of the transformer 2 may rise to be higher than the threshold temperature OTL1. Thus, by adjusting the threshold temperature of the period of this state S2, the threshold temperature may be switched such that the rise in the temperature described above is not detected. For example, a threshold temperature OTL1A and a threshold temperature OTL2A replacing the threshold temperature OTL1 and the threshold temperature OTL2 are set. The threshold temperature OTL1A and the threshold temperature OTL2A are set to be respectively higher than the threshold temperature OTL1 and the threshold temperature OTL2. In accordance with this, a state exceeding the threshold temperature OTL1A is not detected. More specifically, although the signal TAN is “1”, the signal CBCL1 is “0”, and thus the output of the gate 61 becomes “0”, whereby “0”s of the signal OHAS and the control signal SOHA are stored.

When it is a time t22, the temperature of the transformer 2 changes to fall. The reason for this is that heat accumulated in the transformer 2 is transferred to the casing 11 in accordance with emission of the heat accumulated in the transformer 2 and natural convection inside the casing 11, and the heat is emitted from the surface of the casing 11 to the outside thereof.

In this way, although the temperature of the transformer 2 gradually falls, in a stage in which the temperature of the transformer 2 is higher than the threshold temperature OTL1, it is not appropriate to rerestart conduction in the transformer 2.

Thus, in a stage (a time t31) in which the temperature of the transformer 2 has fallen to the threshold temperature OTL1, a case in which conduction in the transformer 2 is restarted by controlling the input-side circuit breaker CB will be described as an example.

As described above, at the time t31, the temperature determining unit 5 controls the input-side circuit breaker CB using a control signal SOHA output through the terminal OHA. The input-side circuit breaker CB becomes a conductive state in accordance with this control, and the signal CBCL1 becomes “1”. This state is a state (state S3) in which electric power is supplied to the transformer 2. In accordance with this, the transformer 2 supplies electric power to the load thereof again, whereby a state in which the fan 11F is operating is formed.

Hereinafter, an overview of the operation in the state S3 will be described first. For example, power consumption of a load at a start time point of the state S3 and power consumption at an end time point of the state S1 are the same, power losses of the transformer 2 at the start time point of the state S3 and the end time point of the state S1 are the same as well. In this situation, the amounts of heat generation of the transformer 2 become equivalent to each other.

However, the situation of the inside of the casing 11 is different between the start time point of the state S3 and the end time point of the state S1. When the start time point of the state S3 and the end time point of the state S1 are compared with each other, temperatures of the inside of the casing 11 are different from each other. The temperature of the inside of the casing 11 at the start time point of the state S3 is higher than the temperature of the inside of the casing 11 at the end time point of the state S1. For this reason, immediately after restart of conduction, the transformer 2 is not sufficiently cooled, and the temperature of the transformer 2 rises after the time t31.

As a result, in accordance with the signal TAN becoming “1” again and the signal CBCL1 being “1”, the output of the gate 61 becomes “1”, whereby “1” is output to the signal OHAS for a short time, and “0” of the control signal SOHA is stored.

Thereafter, a peak of the temperature of the transformer 2 appears at a time t32. In accordance with a cooling effect according to the fan 11F, the temperature of the transformer 2 falls, and the temperature of the transformer 2 is below the threshold temperature OTL1 at a time t33. In accordance with the signal TAN becoming “0” and the signal CBCL1 being “1”, the output of the gate 61 becomes “0”, whereby “0”s of the signal OHAS and the control signal SOHA are stored.

As described above, since the temperature of the transformer 2 at the time point of the time t31 is the same as the threshold temperature OTL1, a rise in the temperature of the transformer 2 that occurs after the time t31 is detected by the comparator 53. The input-side circuit breaker CB is in a conductive state, and the state signal CBCL1 transitions to “1”. The output of the one-shot gate 59 is “1” at the time point of the time t31. For this reason, the gate 61 is activated, and a result of detection acquired by the comparator 53 is output from the gate 61. As a result, “1” of a signal representing a temperature abnormality of the transformer 2 detected by the comparator 53 is output to the signal OHAS from the output of the gate 65. This phenomenon can be allowed on the basis of design, and it is not appropriate to output a signal generated at this time as a signal (“1” of the control signal SOHA) representing a warning.

Thus, in a case in which “1” of the signal representing a temperature abnormality of the transformer 2 detected by the comparator 53 is output as the signal OHAS from the output of the gate 65, the gate 58 and the one-shot gate 59 respond to this, and the one-shot gate 59 outputs a pulse of “0” that continues for a predetermined time to the output thereof. This pulse of “0” is supplied from the one-shot gate 59 to the gate 61, the gate 61 is deactivated, and the output of the gate 61 becomes “0”. As a result, “a signal representing a temperature abnormality of the transformer 2 detected by the comparator 53” is masked by the gate 61, and a pulse of “1” having a short time width is molded. In accordance with this, the signal OHAS output by the gate 65 also becomes the pulse of “1” having a short time width described above.

As described above, a pulse having a relatively short time width based on “the signal representing a temperature abnormality of the transformer 2 detected by the comparator 53” is included in the signal OHAS output by the gate 65. Thereafter, the filter 67 of a later stage limits this pulse, whereby a signal representing a temperature abnormality of the transformer 2 does not appear in the control signal SOHA of the output of the filter 67. In accordance with this, the control signal SOHA output by the terminal OHA does not rattle, and the temperature of the transformer 2 at a hot start time can be stably detected. A time in which “the signal representing a temperature abnormality of the transformer 2 detected by the comparator 53” is to be masked using a signal generated by this one-shot gate 59 is set to a relatively short time, and thus there is no miss of detection of an important phenomenon during the time. For example, when an important phenomenon to be detected occurs, “the signal representing a temperature abnormality of the transformer 2 detected by the comparator 53” continues for the time to be masked or more. Such an important phenomenon to be detected can be detected without being masked, and thus a signal representing an abnormality is output to the control signal SOHA of the terminal OHA in accordance with this.

According to the embodiment described above, the overtemperature detecting system 5A detects a temperature abnormality of the transformer 2 (a dry-type transformer) cooled by the fan 11F (a cooling device). The overtemperature detecting system 5A includes the temperature determining unit 5. The temperature determining unit 5 determines a temperature abnormality of the transformer 2 by changing determination conditions of the temperature abnormality of the transformer 2 using operation states during operating and during stopping of the fan 11F, thereby being able to detect a temperature abnormality of the transformer 2 cooled by the fan 11F. By determining and outputting a temperature abnormality of the transformer 2, the overtemperature detecting system 5A may be used for protection of the transformer 2.

In addition, the temperature determining unit 5 may restrict an output of a result of identification of a temperature abnormality until predetermined conditions are satisfied at a hot start time of the transformer 2. For example, in a case in which the temperature of the transformer 2 is over the first threshold temperature at the hot start time of the transformer 2, the temperature of the transformer 2 being lower than the first threshold temperature may be included in the predetermined conditions.

In addition, by detecting a transition to a hot-line state of the primary side of the transformer 2, the temperature determining unit 5 may identify the hot start time of the transformer 2. For example, by detecting a state of the input-side circuit breaker CB disposed on the primary side of the transformer 2, the temperature determining unit 5 can identify a hot start time of the transformer 2.

In this way, even when it is determined that a rise in an internal temperature of the casing 11 has risen to the threshold temperature OTL1 or more, the temperature determining unit 5 does not necessarily determine a temperature abnormality in accordance therewith. The temperature determining unit 5 does not handle an event of detection of a temperature over the threshold temperature OTL1 as a temperature abnormality for which the output of the transformer 2 needs to be stopped but enables selection for continuation of the operation. There are cases in which the temperature determining unit 5 causes an operation to be continued without determining a temperature abnormality in a predetermined period at the time of restarting conduction according to a hot start. In this period, the load may be operated using an amount of power that is similar to that of a state of a normal time without adjusting the power consumption of the operation of the load.

### Modified Example of Embodiment

A modified example will be described. In the embodiment, a case in which a temperature difference based on detection results acquired by two temperature detectors including the first temperature detector 31 and the second temperature detector 32 is used for determination has been described. By changing this, a temperature detected by the second temperature detector 32 may be used for determination by using only the second temperature detector 32.

### Second Embodiment

A second embodiment will be described.

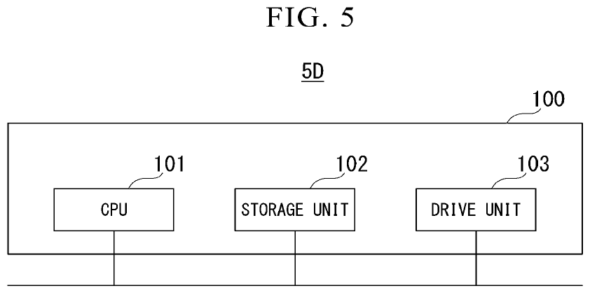

In this embodiment, a temperature determining unit 5D that realizes a similar function using digital processing will be described. FIG. 5 is a block diagram of the temperature determining unit 5D according to the second embodiment. For example, the temperature determining unit 5D includes a processing circuit 100. The processing circuit 100 illustrated in FIG. 5 includes a CPU 101, a storage unit 102, and a drive unit 103. The CPU 101, the storage unit 102, and the drive unit 103 are connected through a bus. The processing circuit 100 is one example of the temperature determining unit 5D. The CPU 101 includes a processor that performs a desired process in accordance with a software program. The storage unit 102 includes a semiconductor memory. The drive unit 103 detects various signals and further generates a control signal of an input-side circuit breaker CB in accordance with control of the CPU 101.

In the embodiment, processes performed by the CPU 101 and the drive unit 103 will be described together simply as a process of the temperature determining unit 5D. For example, like the temperature determining unit 5 described above, the temperature determining unit 5D is connected to a first temperature detector 31 and a second temperature detector 32 disposed inside a casing 11. In addition, a state signal of the input-side circuit breaker CB is supplied to the temperature determining unit 5D such that a hot line state of a primary side of a transformer 2 is detected. The state signal of the input-side circuit breaker CB may be a signal that represents a power application state of a load side of the input-side circuit breaker CB. Furthermore, the temperature determining unit 5D may output a control signal used for controlling the state of the input-side circuit breaker CB such that supply of electric power to the primary side of the transformer 2 is cut off. Processes performed by the CPU 101 and the drive unit 103 in relation with this may be similar to the operations according to the first embodiment described above.

According to the embodiment described above, effects similar to those of the first embodiment can be acquired.

According to at least one of the embodiments described above, an overtemperature detecting system detects a temperature abnormality of a dry-type transformer (hereinafter, referred to as a transformer) cooled by a cooling device. The overtemperature detecting system includes a temperature determining unit. The temperature determining unit determines and outputs a temperature abnormality of the transformer described above by changing determination conditions of the temperature abnormality of the transformer described above using operation states of the cooling device described above during operating and during stopping. In accordance with this, the overtemperature detecting system can detect a temperature abnormality of the transformer cooled by the cooling device.

Although several embodiments of the present invention have been described, such embodiments are presented as examples and are not intended for limiting the scope of the invention. These embodiments can be performed in other various forms, and various omissions, substitutions, and changes can be made in a range not departing from the concept of the invention. Similar to these embodiments and modifications thereof being included in the scope and the concept of the invention, they are included in the invention described in the claims and a range equivalent thereto.

### REFERENCE SIGNS LIST

1 Transformer board
2 Transformer
5A Overtemperature detecting system
10 Overtemperature protecting system
11 Casing
11F Fan (cooling device)
31 First temperature detector
32 Second temperature detector
5, 5D temperature determining unit
CB input-side circuit breaker

1. An overtemperature detecting system detecting a temperature abnormality of a dry-type transformer cooled by a cooling device, the overtemperature detecting system comprising:
a temperature determining unit configured to determine and output a temperature abnormality of the transformer by changing determination conditions of the temperature abnormality of the transformer using operation states during operating and during stopping of the cooling device,
wherein the temperature determining unit is further configured to restrict output of an identification result of a temperature abnormality until the temperature of the transformer satisfies a predetermined temperature condition at a hot start time of the transformer.

2. The overtemperature detecting system according to claim 1,
wherein the cooling device includes a fan for cooling,
wherein the transformer is installed inside a casing in which the fan for cooling is disposed, and
wherein, in a case in which the temperature of the transformer is over a first threshold temperature used for determining the temperature of the transformer at a hot start time of the transformer, the temperature of the transformer falling to be lower than the first threshold temperature is included in the predetermined condition.

3. The overtemperature detecting system according to claim 1, wherein, as the determination conditions of the temperature abnormality of the transformer, threshold temperatures including a first threshold temperature used for determining a temperature of the transformer during operating of a fan for cooling and a second threshold temperature used for determining a temperature of the transformer during stopping of the fan for cooling are provided.

4. (canceled)

5. An overtemperature detecting system detecting a temperature abnormality of a dry-type transformer cooled by a cooling device, the overtemperature detecting system comprising:
a temperature determining unit configured to determine and output a temperature abnormality of the transformer by changing determination conditions of the temperature abnormality of the transformer using operation states during operating and during stopping of the cooling device,
wherein the cooling device includes a fan for cooling,
wherein the transformer is installed inside a casing in which the fan for cooling is disposed,
wherein the temperature determining unit is further configured to restrict output of an identification result of the temperature abnormality until a predetermined condition is satisfied at a hot start time of the transformer, and
wherein, in a case in which the temperature of the transformer is over a first threshold temperature used for determining the temperature of the transformer at a hot start time of the transformer, the temperature of the transformer falling to be lower than the first threshold temperature is included in the predetermined condition.

6. The overtemperature detecting system according to claim 1, wherein the temperature determining unit is further configured to identify a hot start time of the transformer by detecting a transition to a hot line state of a primary side of the transformer.

7. The overtemperature detecting system according to claim 1, wherein the temperature determining unit is further configured to identify a hot start time of the transformer by detecting a state of an input-side circuit breaker disposed on a primary side of the transformer.

8. An overtemperature protecting system comprising:
the overtemperature detecting system according to claim 1; and
a drive unit configured to open a switch disposed on a primary side of the transformer in accordance with a detected temperature abnormality of the transformer.

9. An overtemperature detecting method for detecting a temperature abnormality of a dry-type transformer cooled by a cooling device, the overtemperature detecting method comprising:
determining and outputting a temperature abnormality of the transformer using a temperature determining unit by changing determination conditions of the temperature abnormality of the transformer using operation states during operating and during stopping of the cooling device; and
restricting output of an identification result of a temperature abnormality until a predetermined temperature condition is satisfied at a hot start time of the transformer.

10. An overtemperature protecting system comprising:
the overtemperature detecting system according to claim 2; and
a drive unit configured to open a switch disposed on a primary side of the transformer in accordance with a detected temperature abnormality of the transformer.

11. An overtemperature protecting system comprising:
the overtemperature detecting system according to claim 3; and
a drive unit configured to open a switch disposed on a primary side of the transformer in accordance with a detected temperature abnormality of the transformer.

12. An overtemperature protecting system comprising:
the overtemperature detecting system according to claim 5; and
a drive unit configured to open a switch disposed on a primary side of the transformer in accordance with a detected temperature abnormality of the transformer.

13. An overtemperature protecting system comprising:
the overtemperature detecting system according to claim 6; and
a drive unit configured to open a switch disposed on a primary side of the transformer in accordance with a detected temperature abnormality of the transformer.

14. An overtemperature protecting system comprising:
the overtemperature detecting system according to claim 7; and
a drive unit configured to open a switch disposed on a primary side of the transformer in accordance with a detected temperature abnormality of the transformer.
